(19) United States
(12) Patent Application Publication
(10) Pub. No.: US 2016/0021005 A1
(43) Pub. Date: Jan. 21, 2016

(54) COMMUNICATION SYSTEM, CONTROL APPARATUS AND COMMUNICATION APPARATUS

(71) Applicant: Hitachi, Ltd., Tokyo (JP)

(72) Inventors: Takeshi KIYOSE, Tokyo (JP); Yoshihiro ASHI, Tokyo (JP); Takayuki KANNO, Tokyo (JP); Yasunori OMOTO, Tokyo (JP)

(73) Assignee: HITACHI, LTD., Tokyo (JP)

(21) Appl. No.: 14/735,441

(22) Filed: Jun. 10, 2015

(30) Foreign Application Priority Data
Jul. 15, 2014 (JP) 2014-145002

(51) Int. Cl. H04L 12/743; H04L 12/707; H04L 12/723; H04L 12/721; H04L 12/729

(52) U.S. Cl. CPC H04L 45/7453; H04L 45/66; H04L 45/125; H04L 45/50; H04L 45/24

(57) ABSTRACT

A first communication apparatus and a second communication apparatus are coupled to each other via predetermined communication paths. The control apparatus is configured to: acquire an available bandwidth in each of the predetermined communication paths; define such sub-paths as to start from the first communication apparatus to reach the second communication apparatus and that one of the sub-paths pass through one of the communication paths; determine sub-path bandwidths for the sub-paths in accordance with the acquired available bandwidths; and transmit information for identifying each of the sub-paths and information indicating the sub-path bandwidths to the first communication apparatus by including the information in a setting instruction to set the sub-paths for the first communication apparatus and the second communication apparatus.

### CLAIM OF PRIORITY

The present application claims priority from Japanese patent application JP2014-145002 filed on Jul. 15, 2014, the content of which is hereby incorporated by reference into this application.

### BACKGROUND

This invention relates to a communication system. A communication network service provided by a telecommunications carrier is regarded as an infrastructure essential to our lives and corporate activities. A packet transport technology is used for such a communication network service, and in recent years, the communication network service has been spreading to such a wider area as to achieve nationwide coverage.

Further, an international communication network service business has been promoted with the aim of creating an environment that allows the communication network service to be used not only domestically but also in an overseas base of a corporation. Therefore, the communication network service needs to be provided across a national boundary, which necessitates use of an international connection line.

The communication network service provided by a telecommunications carrier includes a leased line service employed for a corporate backbone network that is particularly high in use frequency and that requires large capacity and a leased line service employed for a task network that may be a lifeline of the corporate activities. Those leased line services are required to be a network having high quality, high reliability, and large capacity.

In the leased line service, a logical path is generally used as a network that meets demands for the high quality, the high reliability, and the like. The logical path used in the leased line service is a path designed and explicitly set by the telecommunications carrier.

In a case of using the logical path, the telecommunications carrier may easily conduct identification of the location of a failure at the time of occurrence of the failure, path management, and bandwidth management within the path. The logical path is, for example, a packet transport relay network using a multi-protocol label switching (MPLS) technology.

In a case where the communication network service is provided in a broad range, the telecommunications carrier uses a relay network to couple networks installed in a plurality of regions to one another. In recent years, an access line of the network installed in the region has been attaining a broader band. On the other hand, the relay network provides a bandwidth narrower than the bandwidth of the access line, which raises a problem of insufficient bandwidth within the relay network.

For example, in a case where the relay network includes a segment in which a line such as an international connection line is difficult to install, the insufficient bandwidth within the segment in which the line is difficult to install is a bottleneck for an entire network in which the communication network service is provided. A method of resolving the insufficient bandwidth within a limited segment includes a traffic distribution technology based on division of the line.

In a case where the networks, which are installed in a plurality of regions and are not directly coupled to one another, are coupled to one another through the relay network, there is proposed a traffic distribution technology for the relay network (see, for example, JP 2003-110604 A). In JP 2003-110604 A, there is the following description: “A client server system for conducting data communications between a client and a server includes: means for establishing a plurality of connections including a plurality of different paths on a network; and distribution means for transmitting transmission data to the plurality of connections in a distributed manner and restoring original data from distributed data received via the plurality of connections.”

### SUMMARY

When networks are installed in a plurality of regions with insufficient lines configured to couple the networks to one another, it is highly possible that the bandwidth becomes insufficient between the networks. Therefore, it is difficult for such a plurality of networks to provide a high quality communication service, and it is necessary to increase communication quality between the networks.

Traffic distribution technologies developed so far realize traffic distribution between adjacent apparatus that are physically connected directly to each other, and increases the communication quality between the adjacent apparatus. However, the related art does not realize the traffic distribution between the networks that are installed in a plurality of regions and are not physically connected directly to each other. For example, the related art does not achieve the traffic distribution between the regions via the relay network such as a packet transport network.

Further, when the technology of JP 2003-110604 A is applied to the network between the regions, it is not possible to sufficiently provide such communications having high quality and high maintainability as to be demanded for, for example, the leased line service.

It is an object of this invention to provide a method of realizing traffic distribution between distant regions via a relay network constructed of communication paths having high quality, reliability, and maintainability.

A representative example of this invention to solve the above problem is a communication system for transferring a packet, including a first communication apparatus, a second communication apparatus and a control apparatus coupled to the first communication apparatus and the second communication apparatus.

The first communication apparatus and the second communication apparatus are coupled to each other via predetermined communication paths, a number of which is defined in advance.

The control apparatus holds path information for identifying the predetermined communication paths coupling the first communication apparatus and the second communication apparatus to each other. The control apparatus acquires an available bandwidth in each of the predetermined communication paths. The control apparatus defines, by using the path information, such sub-paths as to start from the first communication apparatus to reach the second communication apparatus and that one of the sub-paths passes through one of the predetermined communication paths. The control apparatus determines sub-path bandwidths for the sub-paths in accordance with the acquired available bandwidths. The control apparatus transmits information for identifying each of the sub-paths and information indicating the sub-path bandwidths to the first communication apparatus by including the information in a setting instruction to set the sub-paths for the first communication apparatus and the second communication apparatus.

The first communication apparatus receives packets bound for the second communication apparatus. The first communication apparatus classifies the received packets into a predetermined number of groups by using a predetermined classification function. The first communication apparatus assigns, based on the setting instruction transmitted from the control apparatus, the groups to the sub-paths respectively in accordance with a ratio among the sub-path bandwidths. The first communication apparatus outputs each of the received packets to the assigned one of the sub-paths.

According to the one embodiment of this invention, a plurality of networks installed in distant regions is coupled to one another with a network that provides high communication quality.

Objects, configurations, and effects other than those described above become apparent from a description of the following embodiment.

### BRIEF DESCRIPTION OF THE DRAWINGS

FIG. 1 is a block diagram for illustrating a communication system according to this embodiment;

FIG. 2 is a block diagram for illustrating a physical configuration of the path controller according to this embodiment;

FIG. 3 is a block diagram for illustrating a physical configuration and a functional configuration of the edge node according to this embodiment;

FIG. 4 is a sequence diagram for illustrating processing for setting the path 400 in the edge node according to this embodiment;

FIG. 5 is an explanatory diagram for showing the path information according to this embodiment;

FIG. 6 is an explanatory diagram for showing the sub-path identifier information according to this embodiment;

FIG. 7 is an explanatory diagram for showing the distribution information according to this embodiment;

FIG. 8 is an explanatory diagram for showing the bandwidth information according to this embodiment;

FIG. 9 is a flowchart for illustrating processing for designing the logical path according to this embodiment;

FIG. 10 is a flowchart for illustrating processing conducted when the edge node according to this embodiment receives the packet from the L2SW/router;

FIG. 11A is an explanatory diagram for illustrating processing conducted by the hash function module 102 according to this embodiment;

FIG. 11B is an explanatory diagram for illustrating the packet to which the sub-path identifier according to this embodiment is added;

FIG. 12A is an explanatory diagram for showing the transmission packet information according to this embodiment; and

FIG. 12B is an explanatory diagram for showing a screen for displaying the numbers of packets transmitted to the sub-paths according to this embodiment.

### DETAILED DESCRIPTION OF THE EMBODIMENTS

Traffic distribution technologies developed so far realize traffic distribution between adjacent apparatus that are physically connected directly to each other. Further, the traffic distribution technology disclosed in JP 2003-110604 A, which is used between the networks installed in two regions, is a technology using Transmission Control Protocol/Internet Protocol (TCP/IP) and does not provide communications having sufficiently high quality.

Specifically, the traffic distribution technology disclosed in JP 2003-110604 A has a problem in that, for example, in a case of using TCP, a delay may occur when a packet is transferred, which may lower communication speed, while in a case of using IP, a communication path does not be identified, which may degrade maintainability. Such a technology may not be applied to a communication service such as, for example, a synchronous digital hierarchy (SDH) network, for which high quality, high reliability, and high maintainability are demanded.

In this embodiment, it is assumed to employ a leased line service that uses a packet transport network as a relay network. Further, a logical path between regions, which is contained by client-side apparatus such as layer 2 switches (L2SWs) and routers is divided into a plurality of sub-paths within the packet transport network, and packets are distributed to the sub-paths in accordance with bandwidths set for sub-paths. The sub-paths are set in the packet transport network in advance, to thereby provide a network having high quality, high reliability, and high maintainability.

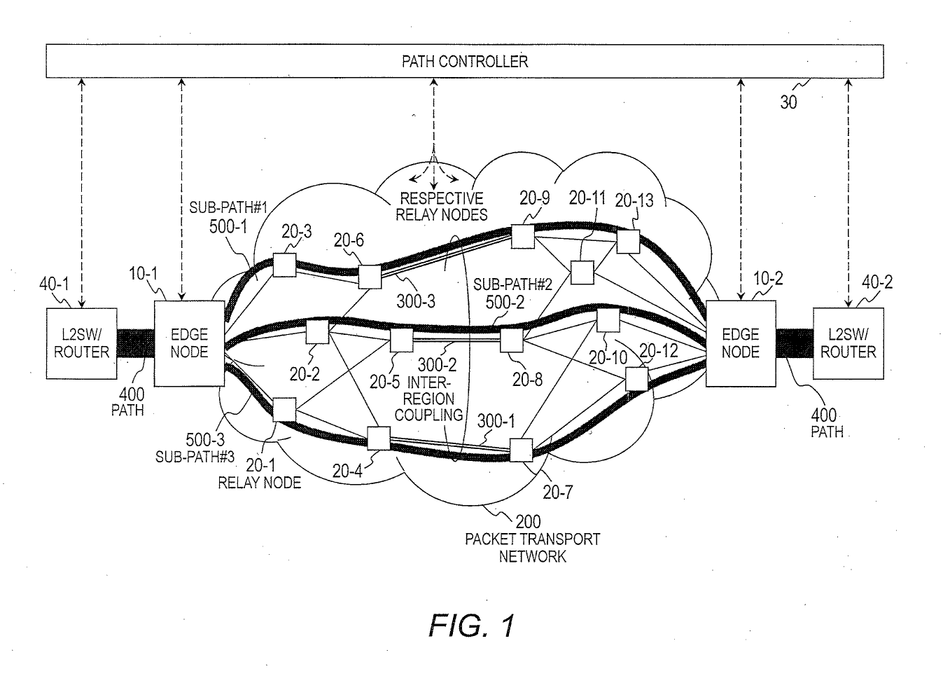

FIG. 1 is a block diagram for illustrating a communication system according to this embodiment.

The communication system according to this embodiment includes a path controller 30, an L2SW/router 40-1, and an L2SW/router 40-2. The L2SW/router 40-1 and the L2SW/router 40-2 are coupled to each other by a packet transport network 200 serving as the relay network. The packet transport network 200 includes an edge node 10-1, an edge node 10-2, and a plurality of relay nodes 20 (20-1 to 20-13).

The L2SW/router 40 is a network apparatus included in a client-side network installed in a region. The L2SW/router 40 may be any kind of network apparatus such as a switch or a router. A network in which the L2SW/router 40-1 is installed and a network in which the L2SW/router 40-2 is installed are respectively installed in distant regions.

The path 400 is a logical path through which the packet passes from the L2SW/router 40-1 set as a start point to the L2SW/router 40-2 set as an end point. The logical path referred to in this embodiment represents a path defined by the start point and the end point, which may pass through any relay node 20 as long as the path passes through the start point and the end point.

The path 400 includes a plurality of sub-paths 500 in the packet transport network 200. A plurality of packets passing through the path 400 are distributed and transferred to the plurality of sub-paths 500 (sub-path (#1) 500-1 to sub-path (#3) 500-3) in the packet transport network 200. It should be noted that the L2SW/router 40 may contain a plurality of paths 400.

The edge node 10 is an edge apparatus within the packet transport network 200, and is a communication apparatus configured to couple the relay node 20 and the L2SW/router 40 to each other. The relay nodes 20-1 to 20-13 are included in the packet transport network 200, and transfer the packet to be transmitted from the edge node 10-1 to the edge node 10-2.

A coupling between two relay nodes 20 within the packet transport network 200 or between the relay node 20 and the edge node 10 includes a plurality of inter-region couplings 300 (300-1 to 300-3). The inter-region coupling 300 is a physical path that uses a communication line configured to relay the packet output from the network installed in each of two regions.

The inter-region coupling 300 may be installed between the regions, for example, across a boundary between two nations, between two islands, or between an island and a continent, where the communication line is difficult to install. The reason that the communication line is difficult to install may be any one of geographical, political, economic, and other such reasons. The inter-region coupling 300 may be a path installed in any region as long as the communication line is not sufficiently installed in the region. The sub-paths 500 are each set to pass through the inter-region coupling 300.

The path controller 30 holds information relating to the edge node 10 and the relay node 20 included in the packet transport network 200. Specifically, the path controller 30 includes a network topology of the edge node 10 and the relay node 20, and more particularly, includes in advance information for identifying the inter-region coupling 300 and the relay node 20 coupled by the inter-region coupling 300.

The path controller 30 is coupled to the L2SW/router 40, the relay node 20, and the edge node 10, and designs and sets the logical path through which the packet is transferred. The path controller 30 according to this embodiment sets the path for every node that the path 400 and the sub-path (#1) 500-1 to the sub-path (#3) 500-3 pass through.

Further, the path controller 30 is a management apparatus for managing the edge node 10 and the relay node 20 by using a management protocol such as simple network management protocol (SNMP). Specifically, the path controller 30 acquires operational situations of the edge node 10 and the relay node 20 and a communication amount thereof from the edge node 10 and the relay node 20.

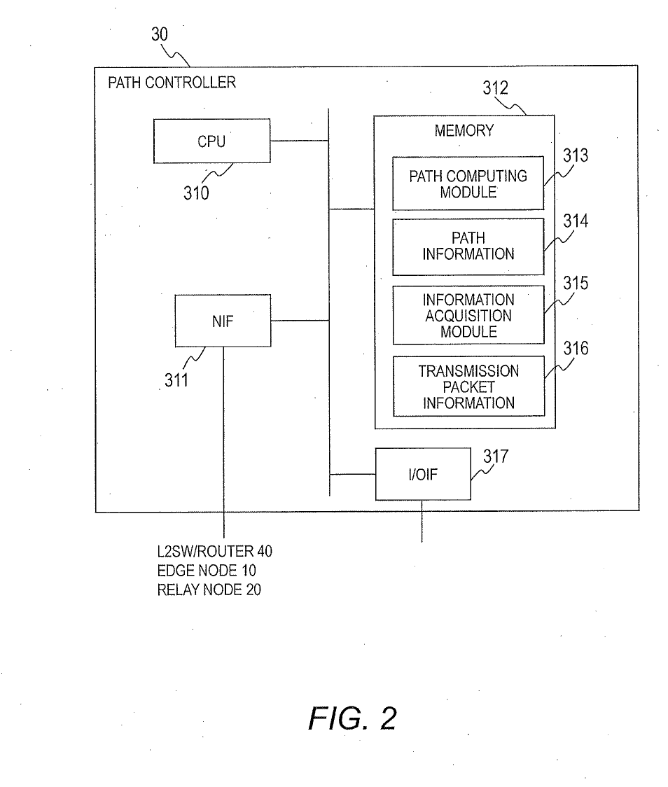

FIG. 2 is a block diagram for illustrating a physical configuration of the path controller 30 according to this embodiment.

The path controller 30 is a computer including a central processing unit (CPU) 310, a network interface (NIF) 311, a memory 312, and an input/output interface (I/OIF) 317. The CPU 310 functions as a computing apparatus and a control apparatus. The CPU 310 may be a processor other than a CPU.

The memory 312 is a storage apparatus for holding data and a program. The CPU 310 implements a function by executing the program by using the memory 312.

The I/OIF 317 is an interface connected to an input/output apparatus. The I/OIF 317 may be, for example, connected to at least one of a display and a printer as output apparatus or connected to at least one of a keyboard and a mouse as input apparatus.

The memory 312 includes, as the programs, a path computing module 313 and an information acquisition module 315. Further, the memory 312 includes, as the data, path information 314 and transmission packet information 316.

The path computing module 313 sets the path for the L2SW/router 40-1, the L2SW/router 40-2, the relay node 20, and the edge node 10. The information acquisition module 315 acquires the number of packets transmitted to the sub-path 500 from the edge node 10.

The path information 314 holds information relating to the sub-path 500 within the packet transport network 200. The transmission packet information 316 holds information relating to the number of packets passing through the sub-path 500. The NIF 311 is a network interface that allows the path controller 30 to communicate to/from the L2SW/router 40, the edge node 10, and the relay node 20. There may be a plurality of NIFs 311.

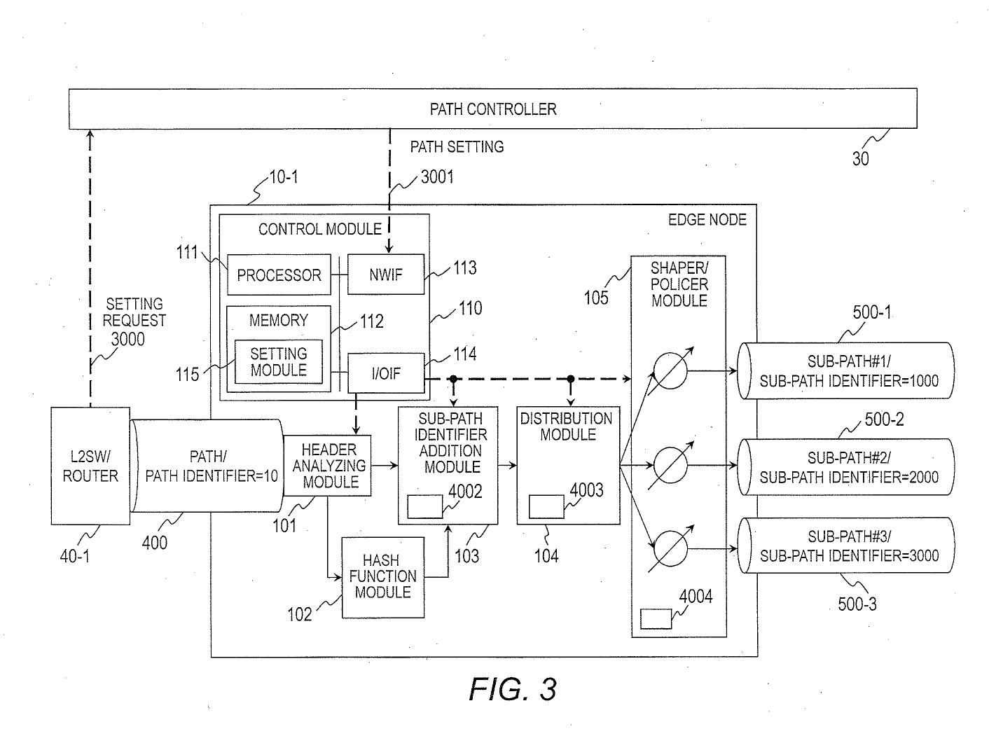

FIG. 3 is a block diagram for illustrating a physical configuration and a functional configuration of the edge node 10-1 according to this embodiment. The same applies to the edge node 10-2.

To set the path 400 with respect to the L2SW/router 40-2 on the opposite side via the packet transport network 200, the L2SW/router 40-1 transmits a setting request 3000 to the path controller 30. When receiving the packet without holding in itself a routing setting for transferring the received packet, the L2SW/router 40-1 transmits the setting request 3000 to the path controller 30. With this operation, the L2SW/router 40-1 requests the path controller 30 for a setting of the path 400.

Then, the path controller 30 transmits, to the edge node 10-1, a path setting 3001 including information for distributing the packets passing through the path 400 to the plurality of sub-paths 500 in accordance with the setting request 3000.

The edge node 10-1 illustrated in FIG. 3 is the edge node 10 through which the packet output from the L2SW/router 40-1 first passes when passing through the packet transport network 200. The edge node 10-1 has a function of distributing the packets passing through the path 400 to the plurality of sub-paths 500.

It should be noted that the sub-path (#1) 500-1 to the sub-path (#3) 500-3 are logical paths, and hence the respective sub-paths 500 do not need to be set in different physical interfaces.

The edge node 10-1 includes, as functional modules, a header analyzing module 101, a hash function module 102, a sub-path identifier addition module 103, a distribution module 104, a shaper/policer module 105, and a control module 110.

The header analyzing module 101 receives the packet from the L2SW/router 40-1 via a network interface (not shown). Then, the header analyzing module 101 extracts identification information for identifying the packet, such as header information, from the received input packet.

The hash function module 102 calculates the information for distributing the input packets to the sub-path (#1) 500-1 to the sub-path (#3) 500-3 with the identification information extracted by the header analyzing module 101 as a key. The hash function module 102 according to this embodiment calculates the hash value as the information for distributing the packets to the sub-paths 500.

The sub-path identifier addition module 103 includes sub-path identifier information 4002. The sub-path identifier information 4002 holds information for assigning a sub-path identifier to the input packet.

The sub-path identifier may be any identifier that uniquely identifies the sub-path 500. For example, the sub-path identifier may be a label of MPLS or a virtual local area network (VLAN) tag. Further, the sub-path identifier may be a value of the IP header in IP encapsulation.

The sub-path identifier addition module 103 extracts the sub-path identifier to be added to each of the input packets based on the input packet transferred from the header analyzing module 101, the information for the distribution calculated by the hash function module 102, and the sub-path identifier information 4002. Then, the sub-path identifier addition module 103 adds the extracted sub-path identifier to the input packet.

The distribution module 104 includes distribution information 4003. The distribution information 4003 holds an identifier indicating a combination of the path 400 and the sub-path 500.

The distribution module 104 distributes the input packet to any one of the plurality of sub-paths 500 by using the distribution information 4003 with the sub-path identifier added to the input packet transferred from the sub-path identifier addition module 103 as a key.

The shaper/policer module 105 is at least one of a shaper and a policer for controlling a bandwidth for each of the sub-paths 500. The shaper/policer module 105 includes bandwidth information 4004. The bandwidth information 4004 holds a set bandwidth indicated by the path setting 3001 transmitted from the path controller 30.

The shaper/policer module 105 outputs the input packet toward the relay node 20. Then, the shaper/policer module 105 controls the bandwidth for the packet to be output to the relay node 20 in accordance with the path setting 3001 transmitted from the path controller 30.

In this manner, the edge node 10-1 distributes the plurality of packets passing through the path 400 to the sub-path (#1) 500-1 to the sub-path (#3) 500-3, and hence it suffices that the L2SW/router 40-1 holds only the identifier (path identifier) of the path 400 that is a main path, which alleviates loads on path management conducted by the L2SW/router 40-1.

The control module 110 updates the information included in the functional modules of the edge node 10-1 in accordance with the path setting 3001 transmitted from the path controller 30. The control module 110 includes a processor 111, a memory 112, a network interface (NWIF) 113, and an I/OIF 114.

The processor 111 is, for example, a CPU, and functions as a computing apparatus and a control apparatus. The NWIF 113 is a network interface configured to couple the edge node 10-1 and the path controller 30 to each other. It should be noted that the network interface for receiving the packet from the L2SW/router 40-1 and the network interface for coupling to the path controller 30 may be the same network interface or may be different network interfaces.

The memory 112 is a storage apparatus for holding data and a program. The I/OIF 114 is an interface configured to couple the header analyzing module 101, the sub-path identifier addition module 103, the distribution module 104, and the shaper/policer module 105 to the control module 110.

The memory 112 includes the setting module 115 as the program. The processor 111 executes the setting module 115. The setting module 115 updates the information included in the functional modules of the edge node 10-1 in accordance with the path setting 3001.

It should be noted that the edge node 10-1 may include a processor (not shown), a memory (not shown), and a network interface (not shown) in addition to the processor and the like included in the control module 110.

In the following description, the path identifier of the path 400 is “10”. Further, the sub-path identifier of the sub-path (#1) 500-1 is “1000”, the sub-path identifier of the sub-path (#2) 500-2 is “2000”, and the sub-path identifier of the sub-path (#3) 500-3 is “3000”.

It should be noted that the header analyzing module 101, the sub-path identifier addition module 103, the distribution module 104, the shaper/policer module 105, and the control module 110 may be implemented by a plurality of physical apparatus each including the processor and the memory, and may also be implemented by one physical apparatus including at least one processor and at least one memory.

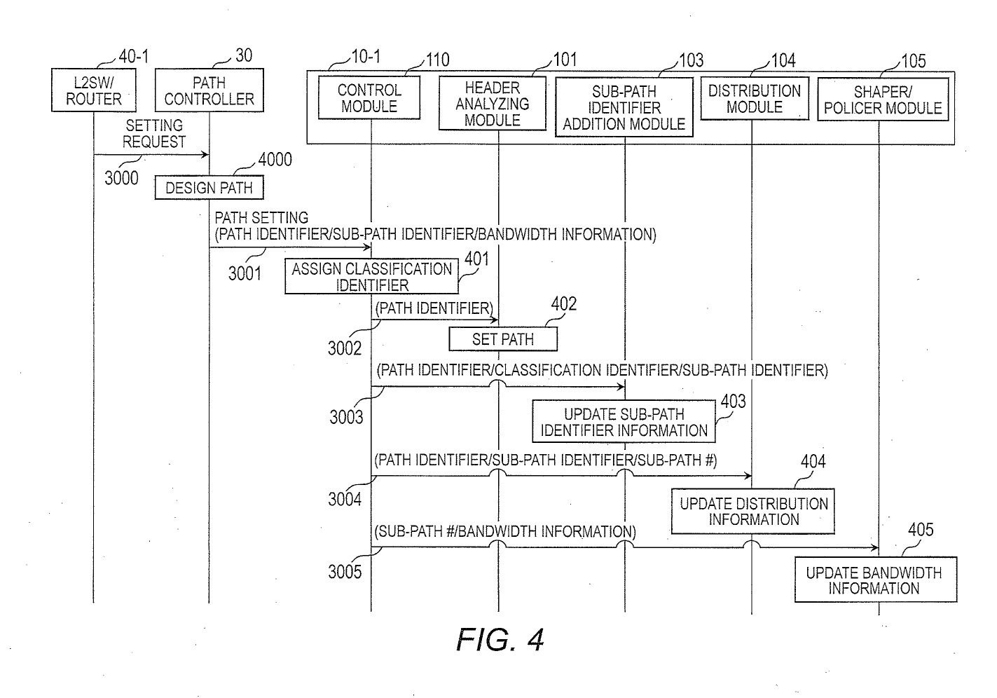

FIG. 4 is a sequence diagram for illustrating processing for setting the path 400 in the edge node 10 according to this embodiment.

The L2SW/router 40-1 transmits the setting request 3000 to the path controller 30. This is because the L2SW/router 40-1 does not need to hold the information relating to the path within the packet transport network 200, while the path controller 30 holds the information relating to the path within the packet transport network 200.

The setting request 3000 includes at least the information indicating the identifier of the L2SW/router 40-1 that is the start point of the path 400, the identifier of the L2SW/router 40-2 that is the end point of the path 400, and the bandwidth necessary for the path 400.

When receiving the setting request 3000 from the L2SW/router 40-1, the path computing module 313 of the path controller 30 designs the path 400 and the plurality of sub-paths 500. Specifically, the path computing module 313 determines the path identifier of the path 400 between the start point and the end point indicated by the setting request 3000 and the information relating to the plurality of sub-paths (#1) 500-1 to (#3) 500-3 (4000).

It should be noted that even when the L2SW/router 40-1 does not transmit the setting request 3000, the path controller 30 according to this embodiment may start the sequence 4000 when an administrator or the like directly inputs the setting request 3000 to the path controller 30 or when another apparatus transmits the setting request 3000.

In the sequence 4000, the path computing module 313 determines the information relating to the sub-paths (#1) 500-1 to (#3) 500-3 based on the information held by the path controller 30, the information on an available bandwidth in the inter-region coupling 300 acquired from the packet transport network 200, and the setting request 3000. Specifically, the information relating to the sub-paths (#1) 500-1 to (#3) 500-3 represents the identifiers of the sub-paths (#1) 500-1 to (#3) 500-3, the relay nodes 20 through which the sub-paths (#1) 500-1 to (#3) 500-3 each pass, and the bandwidths for the sub-paths (#1) 500-1 to (#3) 500-3.

In the sequence 4000, the path computing module 313 determines the relay nodes 20 through which the sub-path 500 passes so that the inter-region coupling 300 is passed through. Therefore, the number of sub-paths 500 is equal to or smaller than the number of inter-region couplings 300. The number of sub-paths 500 determined by the path computing module 313 may be smaller than the number of inter-region couplings 300 when the path computing module 313 acquires in advance information for identifying the inter-region coupling 300 that does not allow the packet to pass therethrough, such as when a failure has occurred or when an instruction is received from the administrator or the like.

The path computing module 313 stores the determined information relating to the sub-path 500 in the path information 314. The design of the path in the sequence 4000 is described later. The path computing module 313 transmits the information (sub-path identifier) relating to the sub-path 500 designed in the sequence 4000, the path identifier, and the set bandwidth (bandwidth information) set in the sub-path 500 (path setting 3001), to the edge node 10-1.

It should be noted that in order to set the determined sub-path 500 in the packet transport network 200, the path computing module 313 may instruct each of the edge node 10-2 and the relay node 20 to set the sub-path 500. Further, any one of the apparatus within the packet transport network 200 may be instructed to set the determined sub-path 500. The path computing module 313 may employ any method as long as the determined sub-path 500 is set in the packet transport network 200.

In addition, the path computing module 313 transmits information (address or the like) for identifying the edge node 10-1 on the start point side and the path identifier to the L2SW/router 40-1, and transmits information (address or the like) for identifying the edge node 10-2 on the end point side and the path identifier to the L2SW/router 40-2.

This allows the L2SW/router 40-1 to transmit the packet, to which the path identifier of the path 400 is added, to the edge node 10-1, and allows the L2SW/router 40-2 to delete the path identifier when the path identifier of the path 400 is added to the received packet.

The relay node 20 sets the sub-path 500 in itself in accordance with the information transmitted from the path controller 30. Further, the L2SW/router 40 sets the path 400 in itself in accordance with the information transmitted from the path controller 30.

When the NWIF 113 of the edge node 10-1 receives the path setting 3001, based on the received information, the setting module 115 assigns a plurality of classification identifiers, which are held in advance, to the sub-path identifiers of the plurality of sub-paths 500 (401).

In this case, the classification identifier is an identifier that uniquely indicates a classified group in a case where the packets received by the edge node 10-1 are classified into a fixed number of groups by a predetermined classification function. The predetermined classification function described below is a function of classifying destination addresses included in the packets by using a hash function. However, the classification function according to this embodiment may employ any method as long as the packets can be classified into a fixed number of classification identifiers.

For example, the setting module 115 adds a numerical value of a port number to a numerical value of the destination address included in the packet, and may classify addition results thereof by using the hash function. Further, when a time at which the edge node 10-1 receives the packet is added to the packet, the setting module 115 may classify addition results thereof by using seconds of the time as the classification identifier.

Further, the number into which the packets are classified by the setting module 115 may be an arbitrary number as long as the number is a plural number and a fixed number. This is because the setting module 115 divides a plurality of classification identifiers in accordance with a ratio among the bandwidths determined for the respective sub-paths 500.

In the sequence 401, the setting module 115 divides the plurality of classification identifiers based on the ratio among the bandwidths for the respective sub-paths 500 indicated by the received information. For example, in a case where the bandwidth determined for the sub-path (#1) 500-1 is 500 mega (M) bits, the bandwidth determined for the sub-path (#2) 500-2 is 250 Mbits, the bandwidth determined for the sub-path (#3) 500-3 is 250 Mbits, and the number of classification identifiers is 256 (classification identifiers: 0 to 255), the setting module 115 divides the classification identifiers into groups of 128 (classification identifiers: 0 to 127), 64 (classification identifiers: 128 to 191), and 64 (classification identifiers: 192 to 255).

Then, the setting module 115 assigns the classification identifiers “0 to 127” to the sub-path (#1) 500-1, assigns the classification identifiers “128 to 191” to the sub-path (#2) 500-2, and assigns the classification identifiers “192 to 255” to the sub-path (#3) 500-3.

It should be noted that when the number of classification identifiers is smaller than the number of sub-paths 500 indicated by the received information, the setting module 115 may assign one classification identifier to one sub-path 500. This allows the edge node 10-1 to distribute the packets to be transmitted to the sub-paths 500 of at least the number of classification identifiers.

After the sequence 401, the setting module 115 sets the path 400 in the header analyzing module 101, the sub-path identifier addition module 103, the distribution module 104, and the shaper/policer module 105 based on the information received from the path controller 30 and assignment results of the sequence 401.

Specifically, the setting module 115 transmits the path identifier of the path 400 to the header analyzing module 101 (3002). The header analyzing module 101 sets the path identifier transmitted from the setting module 115 in the memory held by itself (402).

With this operation, it is possible to determine whether or not the packet input from the L2SW/router 40-1 is the packet to be distributed to the sub-paths (#1) 500-1 to (#3) 500-3. Further, when it is determined that the input packet is the packet to be distributed to the sub-paths (#1) 500-1 to (#3) 500-3, the header analyzing module 101 extracts the information for classifying the packet from the packet.

The setting module 115 transmits the path identifiers of the path 400, the classification identifiers classified in the sequence 401, the sub-path identifiers, and a correspondence among those, to the sub-path identifier addition module 103 (3003).

The sub-path identifier addition module 103 updates the sub-path identifier information 4002 based on the information transmitted from the setting module 115 (403). With this operation, the sub-path identifier addition module 103 adds the sub-path identifier to the input packet.

Further, the setting module 115 transmits the path identifier of the path 400, the sub-path identifier, and a sub-path # that uniquely indicates the correspondence among those to the distribution module 104 (3004). The distribution module 104 updates the distribution information 4003 based on the information transmitted from the setting module 115 (404). This allows the distribution module 104 to distribute the received packets to the sub-paths 500.

Further, the setting module 115 transmits the sub-path # and the information (bandwidth information) indicating the bandwidths determined for the respective sub-paths 500, to the shaper/policer module 105 (3005). The shaper/policer module 105 updates the bandwidth information 4004 based on the information transmitted from the setting module 115 (405). This allows the shaper/policer module 105 to adjust the bandwidth for the packet to be output to the sub-path 500 in accordance with the bandwidth determined by the path controller 30.

By the sequence illustrated in FIG. 4, the edge node 10-1 distributes the packets passing through the path 400 to the plurality of sub-paths 500 in accordance with the determination of the path controller 30. Then, the edge node 10-1 adjusts the bandwidth for the packet to be output to the sub-path 500.

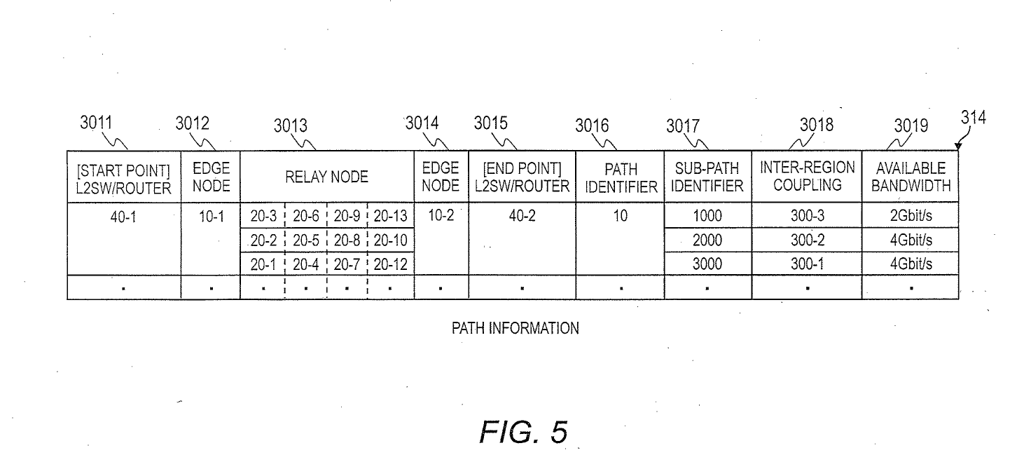

FIG. 5 is an explanatory diagram for showing the path information 314 according to this embodiment.

The path information 314 includes a start point L2SW/router 3011, an edge node 3012, a relay node 3013, an edge node 3014, an end point L2SW/router 3015, a path identifier 3016, a sub-path identifier 3017, an inter-region coupling 3018, and an available bandwidth 3019.

The start point L2SW/router 3011 indicates the L2SW/router 40 of the start point of the path 400 for which the setting has been requested by the setting request 3000. The edge node 3012 indicates the edge node 10 configured to couple to the L2SW/router 40 of the start point without the intermediation of the packet transport network 200.

The end point L2SW/router 3015 indicates the L2SW/router 40 of the end point of the path 400 for which the setting has been requested by the setting request 3000. The edge node 3014 indicates the edge node 10 configured to couple to the L2SW/router 40 of the end point without the intermediation of the packet transport network 200.

The relay node 3013 indicates the relay node 20 through which the sub-path 500 configured to couple the edge node 10 indicated by the edge node 3012 and the edge node 10 indicated by the edge node 3014 to each other passes.

The path identifier 3016 indicates the path identifier of the path 400 for which the setting has been requested by the setting request 3000. The sub-path identifier 3017 indicates the identifier of the sub-path 500 configured to couple the edge node 10 indicated by the edge node 3012 and the edge node 10 indicated by the edge node 3014 to each other.

The inter-region coupling 3018 indicates the identifier of the inter-region coupling 300 included in the packet transport network 200. One inter-region coupling 300 is assigned to one sub-path 500. The available bandwidth 3019 indicates the available bandwidth in the inter-region coupling 300.

The setting request 3000 includes the information stored in the start point L2SW/router 3011, the end point L2SW/router 3015, and the path identifier 3016. Therefore, the path computing module 313 updates the start point L2SW/router 3011, the end point L2SW/router 3015, and the path identifier 3016 based on the setting request 3000.

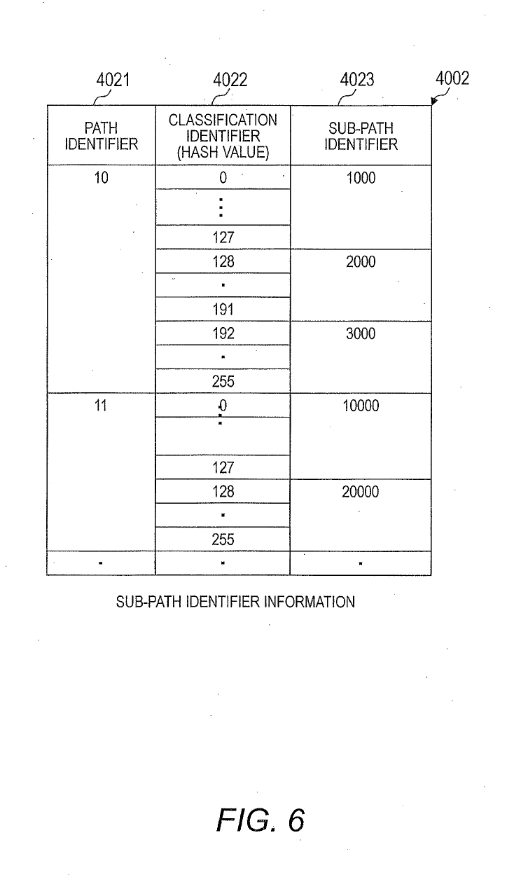

FIG. 6 is an explanatory diagram for showing the sub-path identifier information 4002 according to this embodiment.

The sub-path identifier information 4002 includes a path identifier 4021, a classification identifier 4022, and a sub-path identifier 4023. The path identifier 4021 indicates the path identifier of the path 400.

The classification identifier 4022 is an identifier that uniquely indicates the classified group in a case where the packet is classified by the predetermined classification function. The sub-path identifier 4023 indicates the identifier of the sub-path 500.

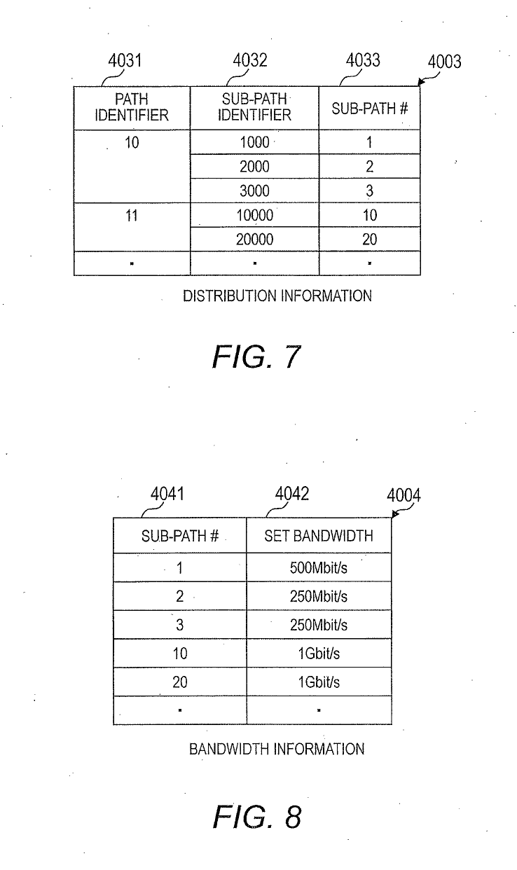

FIG. 7 is an explanatory diagram for showing the distribution information 4003 according to this embodiment.

The distribution information 4003 includes a path identifier 4031, a sub-path identifier 4032, and a sub-path 4033. The path identifier 4031 indicates the path identifier, and corresponds to the path identifier 4021.

The sub-path identifier 4032 indicates the sub-path identifier, and corresponds to the sub-path identifier 4023. The sub-path #4033 indicates an identifier that uniquely indicates a combination of the path identifier and the sub-path identifier.

FIG. 8 is an explanatory diagram for showing the bandwidth information 4004 according to this embodiment.

The bandwidth information 4004 includes a sub-path #4041 and a set bandwidth 4042. The sub-path #4041 uniquely indicates the combination of the path identifier and the sub-path identifier, and corresponds to the sub-path #4033.

The set bandwidth 4042 indicates the bandwidth in the sub-path 500, which is the bandwidth information determined in the sequence 4000, and indicates the bandwidth in the sub-path 500 indicated by the sub-path #4041.

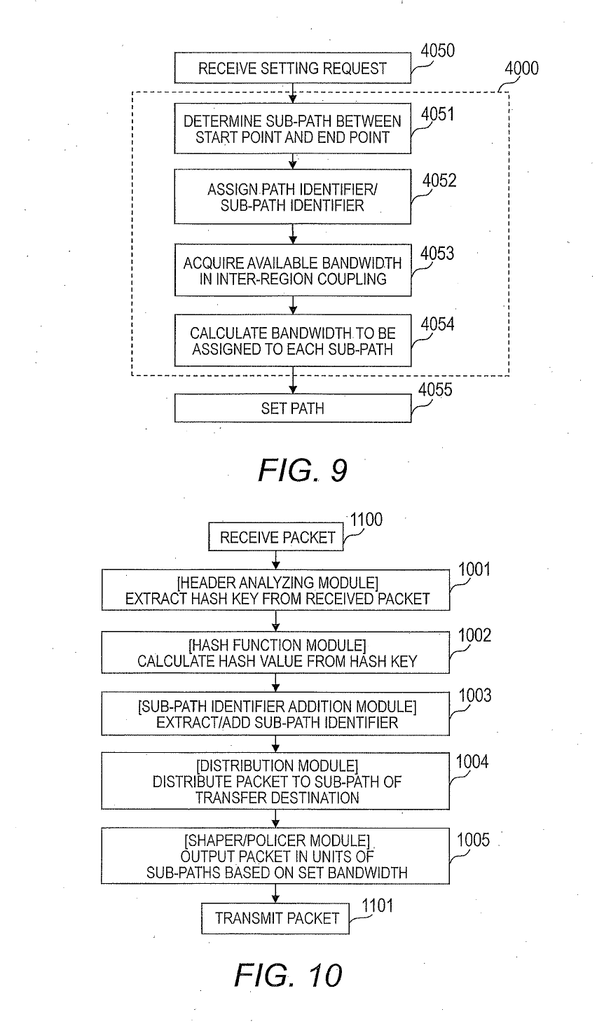

FIG. 9 is a flowchart for illustrating processing for designing the logical path according to this embodiment.

The path computing module 313 of the path controller 30 receives the setting request 3000 (4050). After Step 4050, the path computing module 313 starts the sequence 4000.

In the sequence 4000, the path computing module 313 determines the plurality of sub-paths 500 to be set in the packet transport network 200 between the start point and the end point indicated by the setting request 3000 (4051). The path computing module 313 determines the plurality of sub-paths 500 based on the information held in advance, namely, the information on the network topology and the bandwidth within the packet transport network 200 and the information for identifying the inter-region coupling 300.

Specifically, the path computing module 313 first identifies the edge node 10-1 on the start point side at which the L2SW/router 40-1 of the start point is coupled to the packet transport network 200 and the edge node 10-2 on the end point side at which the packet transport network 200 is coupled to the L2SW/router 40-2 of the end point.

Then, one logical path between the relay node 20 on the start point side of the inter-region coupling 300 and the edge node 10-1 on the start point side and one logical path between the relay node 20 on the end point side of the inter-region coupling 300 and the edge node 10-2 on the end point side are extracted for each inter-region coupling 300. It should be noted that when the inter-region coupling 300 and the edge node 10 are directly coupled to each other, the path computing module 313 does not need to extract the logical path between the edge node 10 and the inter-region coupling 300 that are directly coupled to each other.

The path computing module 313 may extract the logical path by using any method as long as the inter-region coupling 300 is passed through, and may extract the path having a minimum hop count indicating how many relay nodes 20 are passed through as the logical path, or may extract the path that passes through the relay node 20 exhibiting an available bandwidth larger than a predetermined value as the logical path.

Then, in Step 4051, the path computing module 313 determines the path including the extracted logical path on the start point side, the inter-region coupling 300, and the extracted logical path on the end point side, as the sub-path 500 for each inter-region coupling 300.

In Step 4051, the path computing module 313 stores the identifier of the L2SW/router 40 on the start point side indicated by the setting request 3000 in the start point L2SW/router 3011, and stores the identifier of the L2SW/router 40 on the end point side indicated by the setting request 3000 in the start point L2SW/router 3011. Further, the path computing module 313 stores the identifier indicating the edge node 10 on the start point side in the edge node 3012, and stores the identifier indicating the edge node 10 on the side of the end point in the edge node 3014.

Further, in Step 4051, the path computing module 313 stores the identifiers indicating the relay nodes 20 through which the determined plurality of sub-paths 500 pass, in the relay node 3013 of the path information 314 for each sub-path 500. Then, the path computing module 313 stores the identifier indicating the inter-region coupling 300 through which the determined plurality of sub-paths 500 pass in the inter-region coupling 3018.

After Step 4051, the path computing module 313 assigns the path identifier that uniquely indicates the path 400 requested by the setting request 3000 and the sub-path identifier that uniquely indicates each of the determined plurality of sub-paths 500 (4052). Then, the path computing module 313 stores the assigned sub-path identifier in the sub-path identifier 3017.

The path identifier is an identifier to be added to the packet by the L2SW/router 40-1 in order to transfer the packet along the path 400. The edge node 10 refers to the path identifier included in the packet to determine the processing to be conducted for the packet and a destination thereof.

It should be noted that in Step 4052 described above, the path controller 30 assigns the path identifier. However, the path identifier may be any identifier as long as the identifier is unique across the packet transport network 200. Therefore, the path controller 30 may receive the path identifier assigned by the L2SW/router 40, or may receive the path identifier assigned by the administrator.

After Step 4052, the path computing module 313 acquires the available bandwidth in the inter-region coupling 300 through which the determined plurality of sub-paths 500 pass, from the packet transport network 200 (4053). Then, the path computing module 313 stores the acquired available bandwidth in the available bandwidth 3019 so as to correspond to each of the determined sub-paths 500.

After Step 4053, the path computing module 313 calculates the ratio among the available bandwidths 3019 of the path information 314 as the ratio among the bandwidths to be assigned to the respective sub-paths 500. Then, the path computing module 313 calculates amounts of the bandwidths to be assigned to the respective sub-paths 500 based on the calculated ratio and the bandwidth necessary for the path 400 indicated by the setting request 3000 (4054).

This allows the path controller 30 to set the sub-path 500 that efficiently uses the bandwidth in the inter-region coupling 300 that is a bottle neck. It should be noted that in Step 4054, the path computing module 313 may calculate the ratio among the bandwidths to be assigned to the respective sub-paths 500 so that a difference in the available bandwidths among the plurality of inter-region couplings 300 after the sub-path 500 is set falls within a predetermined range among the plurality of inter-region couplings 300.

After Step 4054, the path computing module 313 finishes the sequence 4000, and executes the path setting 3001, to thereby set the path 400 and the plurality of sub-paths 500 in the packet transport network 200. Further, the path computing module 313 sets the path 400 in the L2SW/router 40 (4055).

It should be noted that the sequence 4000 described above with reference to FIG. 4 and FIG. 9 is started after the path controller 30 receives the setting request 3000. However, the path controller 30 according to this embodiment may execute the processing of the sequence 4000 and the subsequent sequences in, for example, a case where a failure is detected in the sub-path 500 and the sub-path 500 in which the failure has occurred needs to be deleted, or a case where an instruction to increase or decrease the sub-paths 500 is received from the administrator.

Specifically, when it is necessary to increase or decrease the sub-paths 500, the path computing module 313 determines the sub-paths 500 after the increase or the sub-paths 500 after the decrease in Step 4051. Then, in Step 4055, the path computing module 313 sets the sub-paths 500 after the increase and the sub-paths 500 after the decrease in the packet transport network 200. At this point, in the case of decreasing the sub-paths 500, the path computing module 313 executes processing for deleting the settings of the sub-paths 500 to be decreased.

Further, when it is detected in advance that a bandwidth being used in the inter-region coupling 300 changes depending on a time slot, the path controller 30 may execute the processing of the sequence 4053 and the subsequent processing at a time at which the bandwidth being used changes. For example, when the path controller 30 holds in advance information indicating the inter-region coupling 300 for which the bandwidth being used increases during night time, the path controller 30 may execute the processing of the sequence 4053 and the subsequent processing at a predefined time (for example, 19:00) every day. Then, the path controller 30 may control the edge node 10-1 to change the set bandwidth in the sub-path 500.

FIG. 10 is a flowchart for illustrating processing conducted when the edge node 10 according to this embodiment receives the packet from the L2SW/router 40.

The L2SW/router 40-1 adds the path identifier of the path 400 to the packet to be transmitted to the L2SW/router 40-2 in accordance with the information on the path setting 3001 transmitted from the path controller 30. Then, the L2SW/router 40-1 transmits the packet to the edge node 10-1. The network interface of the edge node 10-1 receives the packet from the L2SW/router 40-1 (1100).

After Step 1100, the header analyzing module 101 determines whether or not the path identifier added to the received packet is the same as the path identifier held by the memory of its own. When the held path identifier and the path identifier added to the packet are the same, the header analyzing module 101 extracts the information for classifying the packet from the received packet as a hash key (1001).

In other words, when the held path identifier and the path identifier added to the packet are the same, the header analyzing module 101 determines that the received packet is a packet to be distributed to one of the sub-paths 500. Therefore, the L2SW/router 40-1 does not need to hold the information relating to the sub-path 500.

It should be noted that when the held path identifier and the path identifier added to the packet are not the same, the header analyzing module 101 may transfer the received packet by a transfer method other than the method according to this embodiment, which is held in advance, or may discard the received packet.

In this case, the information for classifying the packet is the information for identifying the packet, and is the information used as the hash key in the classification of the packet, which is executed by the hash function module 102. The information for classifying the packet is the destination IP address in this embodiment. However, the information for classifying the packet may be a media access control (MAC) address of a destination or a transmission source, a port number of TCP, or other such information, and this information may be used as the hash key.

In Step 1001, the header analyzing module 101 transmits the extracted hash key to the hash function module 102, and transmits the received packet to the sub-path identifier addition module 103. The hash function module 102 calculates the hash value from the hash key transmitted from the header analyzing module 101 (1002).

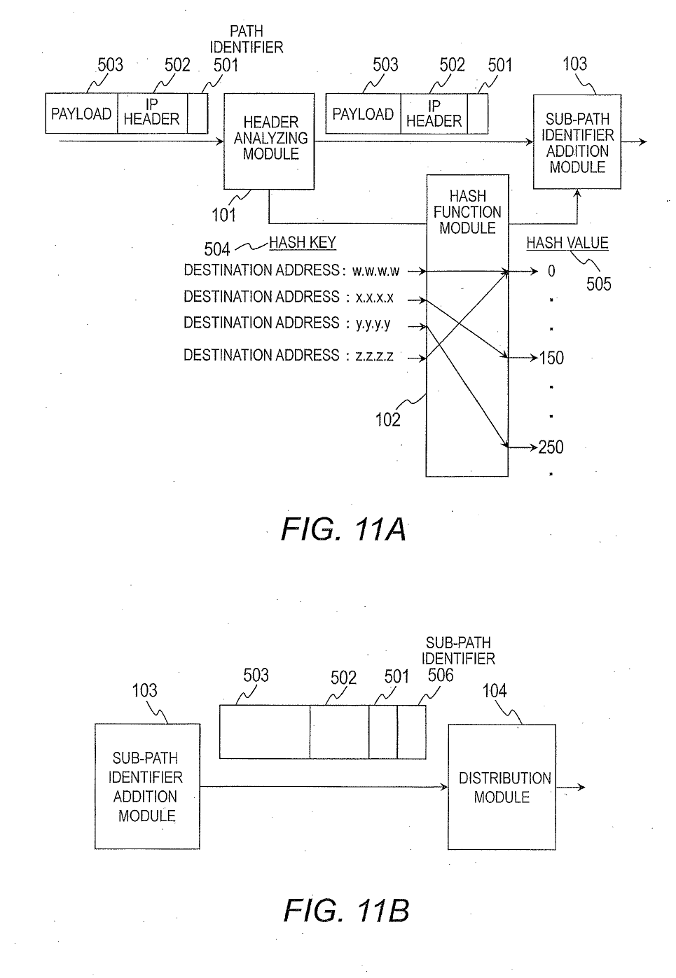

FIG. 11A is an explanatory diagram for illustrating processing conducted by the hash function module 102 according to this embodiment.

In FIG. 11A, the received packet includes a payload 503, an IP header 502, and a path identifier 501. Then, in Step 1001, the header analyzing module 101 extracts the destination IP address from the packet as a hash key 504. The header analyzing module 101 transmits the hash key 504 to the hash function module 102.

After Step 1001, in Step 1002, the hash function module 102 calculates a hash value 505 by using the hash key 504 and the hash function held in advance. The hash function module 102 calculates as many hash values 505 as the number of classification identifiers. In the following description, the classification identifier has the same value as the hash value 505.

In Step 1002, for example, the hash function module 102 calculates the hash value 505 of 8 bits (0 to 255 in decimal digits) with the destination IP address transmitted from the header analyzing module 101 as the hash key 504. In this case, for example, the hash function module 102 may add up every 8 bits of the IP address and calculate the less significant 8 bits of the addition results as the hash value 505.

The hash function module 102 may use any method as long as the hash value 505 having a predetermined bit count can be calculated from the hash key 504. Further, the bit count of the hash value 505 may be 8 bits or may be a bit count other than 8 bits.

The hash function module 102 calculates the hash value based on the information for classifying the packet, to thereby be able to classify the packets into a predetermined number by using indefinite information indicated by the packet. Therefore, the hash function module 102 distributes the packet indicating any value to the sub-path 500.

After Step 1002, the hash function module 102 notifies the sub-path identifier addition module 103 of the calculated hash value 505. The sub-path identifier addition module 103 associates the packet transmitted from the header analyzing module 101 with the hash value 505 notified of by the hash function module 102.

The sub-path identifier addition module 103 may associate the packet with the hash value 505 by any method. The header analyzing module 101 may add an identifier of the apparatus to both the packet and the hash key, the hash function module 102 may add the identifier of the apparatus added to the hash key 504 to the hash value 505, and the sub-path identifier addition module 103 may associate the hash value 505 to which the same identifier of the apparatus is added with the packet. Further, the sub-path identifier addition module 103 may associate the hash values 505 stored in a buffer with the packets one by one both in order from the one received first.

The sub-path identifier addition module 103 extracts an entry in which the path identifier 501 of the associated packet matches the path identifier 4021 and the associated hash value 505 matches the classification identifier 4022, from the sub-path identifier information 4002. Then, the sub-path identifier addition module 103 adds the sub-path identifier 4023 of the extracted entry to the packet as a sub-path identifier 506 (1003).

With this operation, the packets inputted from the L2SW/router 40-1 are distributed in proportion to the ratio among the set bandwidths in the sub-paths 500. Further, it is possible to effectively use a network resource (available bandwidth) within the packet transport network 200.

FIG. 11B is an explanatory diagram for illustrating the packet to which the sub-path identifier 506 according to this embodiment is added.

In FIG. 11B, the packet transmitted by the sub-path identifier addition module 103 includes the payload 503, the IP header 502, the path identifier 501, and the sub-path identifier 506. It should be noted that the path identifier 501 and the sub-path identifier 506 may be added to any part of the packet as long as each of the apparatus such as the edge node 10 and the relay node 20 can refer to the part.

The sub-path identifier 506 is added to the packet received by the edge node 10-1 by the sub-path identifier addition module 103. By referring to the sub-path identifier 506 of the packet, the relay node 20 of the packet transport network 200 transfers the packet along the sub-path 500 determined by the path controller 30.

The addition of the sub-path identifier conducted in Step 1003 according to this embodiment is processing for determining the ratio for distributing the packets but not for adjusting the bandwidth for the packet to be output in actuality. The bandwidth control according to this embodiment is executed by the shaper/policer module 105 in a subsequent stage.

After Step 1003, the sub-path identifier addition module 103 transmits the packet to the distribution module 104. The distribution module 104 extracts an entry in which the path identifier 501 of the received packet matches the path identifier 4031 and the sub-path identifier 506 of the received packet matches the sub-path identifier 4032, from the distribution information 4003.

Then, the distribution module 104 adds the sub-path #4033 of the extracted entry to the packet, and also transmits the packet to the shaper/policer module 105. With this operation, the distribution module 104 distributes the packet to the sub-path 500 of an output destination (1004).

After Step 1004, the shaper/policer module 105 extracts an entry in which the sub-path #4033 added to the packet matches the sub-path #4041, from the bandwidth information 4004. Then, the shaper/policer module 105 adjusts the bandwidth for the packet to be output to the relay node 20 in accordance with the set bandwidth 4042 of the extracted entry (1005). It should be noted that the shaper/policer module 105 deletes the sub-path #4033 added to the packet, and outputs the packet toward the relay node 20.

By adjusting the bandwidth with the shaper/policer module 105, the edge node 10-1 adjusts a traffic flow rate within the packet transport network 200 in accordance with an instruction received from the path controller 30, and suppresses congestion in the network.

After Step 1005, the packet is transmitted toward the relay node 20 for which the sub-path 500 is set, via the network interface of the edge node 10-1 (1101).

According to the above-mentioned processing, based on the information indicated by the received packets and the designated ratio, the received packets are distributed to the plurality of sub-paths 500.

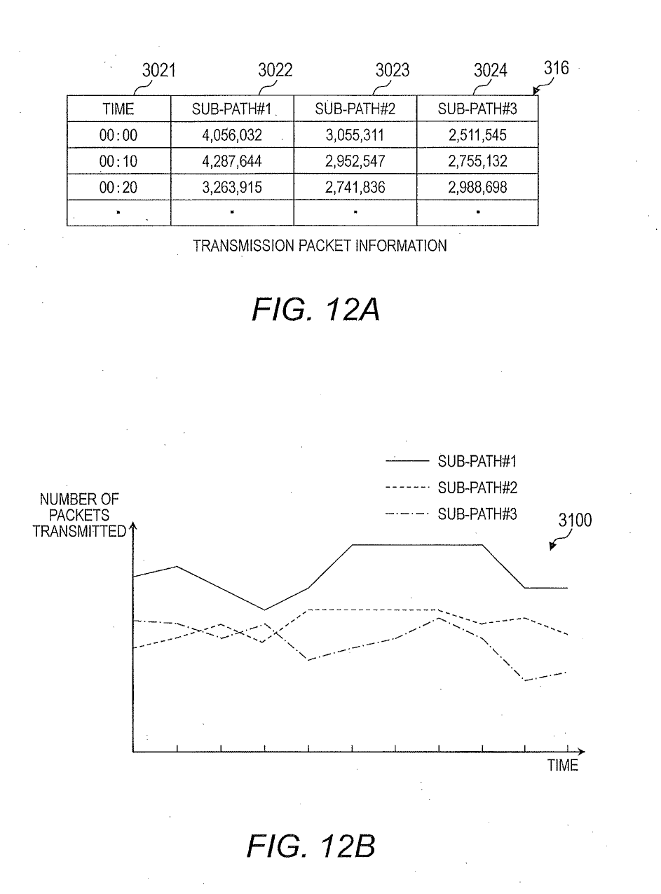

FIG. 12A is an explanatory diagram for showing the transmission packet information 316 according to this embodiment.

The information acquisition module 315 of the path controller 30 acquires the number of packets output from the shaper/policer module 105 of the edge node 10 to the sub-path 500. The information acquisition module 315 stores the acquired number of packets in the transmission packet information 316.

A program (not shown) held by the shaper/policer module 105 or the control module 110 calculates a statistic of the number of packets output by the shaper/policer module 105 for each of the sub-paths 500, and transmits the calculated value to the path controller 30.

The transmission packet information 316 shown in FIG. 12A indicates the number of packets transmitted for the past 10 minutes. The transmission packet information 316 includes a time 3021, a sub-path (#1) 3022, a sub-path (#2) 3023, and a sub-path (#3) 3024.

The time 3021 indicates a representative time among times at which the shaper/policer module 105 has transmitted the packets. The sub-path (#1) 3022, the sub-path (#2) 3023, and the sub-path (#3) 3024 indicate the numbers of packets output to the sub-path (#1) 500-1 to the sub-path (#3) 500-3, respectively, during a predetermined time period.

For example, the sub-path (#1) 3022, the sub-path (#2) 3023, and the sub-path (#3) 3024 may indicate the numbers of packets output to the sub-path (#1) 500-1 to the sub-path (#3) 500-3 for the 10 minutes including the time indicated by the time 3021.

FIG. 12B is an explanatory diagram for showing a screen 3100 for displaying the numbers of packets transmitted to the sub-paths 500 according to this embodiment.

The information acquisition module 315 transmits data for displaying contents of the transmission packet information 316 to the output apparatus via the I/OIF 317 so that the administrator of the packet transport network 200 can view the contents of the transmission packet information 316.

The screen 3100 of FIG. 12B shows time-series transition of the number of packets. The horizontal axis corresponds to the time 3021, and the vertical axis corresponds to the number of packets on the sub-path (#1) 3022, the sub-path (#2) 3023, and the sub-path (#3) 3024. It should be noted that the information acquisition module 315 may acquire a packet discard rate or the like for the sub-path 500, and may display the packet discard rate or the like on the screen 3100.

The administrator of the packet transport network 200 views the screen 3100, to thereby recognize whether or not the packets are being output with the ratio among the available bandwidths for the respective sub-paths 500. When the packets are not being output with the ratio among the available bandwidths for the respective sub-paths 500, the administrator determines that the hash function held by the hash function module 102 is not appropriate or that the hash key extracted from the packet is not appropriate, and sets an appropriate hash function or an appropriate hash key in the edge node 10-1.

According to this embodiment, the edge node 10 distributes the packets input from the L2SW/router 40 to the sub-paths 500 passing through the respective inter-region couplings 300. This allows traffic to be distributed in the packet transport network 200 in which a connection-oriented path is constructed.

With this configuration, it is possible to resolve an insufficient bandwidth in the inter-region coupling 300, and hence the communication system according to this embodiment may provide a communication service having high quality and high reliability. It should be noted that the wording “connection-oriented” used in this embodiment means that a setting of the communication path relating to connection, a coupling relation, or the like is applied to the logical path or the physical path in advance before data transmission.

Further, the path controller 30 sets the plurality of sub-paths 500 in the packet transport network 200, and hence the connection-oriented logical path is constructed. With this configuration, the communication system having high maintainability is constructed.

In addition, the edge node 10 uses the shaper/policer module 105 to limit the bandwidth in the packet transport network 200 and suppress the congestion, and hence it is possible to provide the communication service having high quality and high reliability.

With the above-mentioned configuration, according to this embodiment, it is possible to provide means for realizing traffic distribution between the regions via the packet transport network constructed of the logical paths that are also applied to the leased line service for which the same high quality, reliability, and maintainability as a synchronous digital hierarchy (SDH) network are demanded.

Further, it suffices that the L2SW/router 40 holds only the path identifier of the path 400, and does not need to manage the sub-path 500, which alleviates processing loads on the L2SW/router 40.

It should be noted that this invention is not limited to the above-mentioned embodiment, and includes various modification examples. For example, the above-mentioned embodiment is described in detail for a better understanding of this invention, and is not necessarily limited to one that includes all the described components.

For example, in the above description, the inter-region coupling 300 is the physical path, but the inter-region coupling 300 may be the logical path. Specifically, this embodiment is applied to a case where a plurality of logical paths are set for one physical path configured to couple the edge node 10-1 and the edge node 10-2 to each other as the plurality of inter-region couplings 300 and where a maximum bandwidth is assigned to each of the inter-region couplings 300. In this case, the path controller 30 acquires the available bandwidth from a difference between the bandwidth being used for each of the inter-region couplings 300 and the maximum bandwidth, and defines the sub-path 500 in accordance with the acquired available bandwidth.

Then, in accordance with the instruction from the path controller 30, the edge node 10 sets the sub-path 500 within the inter-region coupling 300 (logical path). With this operation, for example, when the bandwidth being used for the inter-region coupling 300 formed of one logical path is close to the maximum bandwidth, the packets are distributed to the other inter-region couplings 300, which achieves the distribution of the paths through which the packets pass.

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, and processors, for all or a part of them, may be implemented by hardware: for example, by designing an integrated circuit. The above-described configurations and functions may be implemented by software, which means that a processor interprets and executes programs providing the functions. The information of programs, tables, and files to implement the functions may be stored in a storage device such as a memory, a hard disk drive, or an SSD (Solid State Drive), or a storage medium such as an IC card, or an SD card.

The drawings shows control lines and information lines as considered necessary for explanations but do not show all control lines or information lines in the products. It may be considered that almost of all components are actually interconnected.

What is claimed is:

1. A communication system for transferring a packet, comprising:
a first communication apparatus;
a second communication apparatus; and
a control apparatus coupled to the first communication apparatus and the second communication apparatus, wherein:
the first communication apparatus and the second communication apparatus are coupled to each other via predetermined communication paths, a number of which is defined in advance;
the control apparatus is configured to:
hold path information for identifying the predetermined communication paths coupling the first communication apparatus and the second communication apparatus to each other;
acquire an available bandwidth in each of the predetermined communication paths;
define, by using the path information, such sub-paths as to start from the first communication apparatus to reach the second communication apparatus and that one of the sub-paths passes through one of the predetermined communication paths;
determine sub-path bandwidths for the sub-paths in accordance with the acquired available bandwidths; and
transmit information for identifying each of the sub-paths and information indicating the sub-path bandwidths to the first communication apparatus by including the information in a setting instruction to set the sub-paths for the first communication apparatus and the second communication apparatus; and
the first communication apparatus is configured to:
receive packets bound for the second communication apparatus;
classify the received packets into a predetermined number of groups by using a predetermined classification function;
assign, based on the setting instruction transmitted from the control apparatus, the groups to the sub-paths respectively in accordance with a ratio among the sub-path bandwidths; and
output each of the received packets to the assigned one of the sub-paths.

2. The communication system according to claim 1, wherein:
the control apparatus is coupled to a first client-side apparatus directly coupled to the first communication apparatus and a second client-side apparatus directly coupled to the second communication apparatus;
the control apparatus is configured to:
acquire, when receiving a setting request for a main path starting from the first client-side apparatus to reach the second client-side apparatus, information for identifying the main path;
output a setting instruction for setting the main path to the first client-side apparatus, the second client-side apparatus, the first communication apparatus, and the second communication apparatus; and
transmit the information for identifying the main path, the information for identifying each of the sub-paths, and the information indicating the sub-path bandwidths to the first communication apparatus by including the information in the setting instruction;
the first client-side apparatus adds the information for identifying the main path to the packet to be transmitted to the second client-side apparatus; and
the first communication apparatus is configured to:
determine whether or not the information for identifying the main path is added to each of the received packets; and
classify, when the information for identifying the main path is added to the received packet, the received packets by using the predetermined classification function.

3. The communication system according to claim 1, wherein the first communication apparatus is configured to, as the predetermined classification function:
calculate hash values corresponding to the received packets by applying a hash function to information for identifying the received packets; and
classify the received packets based on the hash values.

4. The communication system according to claim 1, wherein the control apparatus is configured to:
acquire a bandwidth for transmitting packets from the first communication apparatus to the second communication apparatus;
calculate a ratio among the acquired available bandwidths for the communication paths; and
calculate each of the sub-path bandwidths for the sub-paths by using the bandwidth for transmitting packets from the first communication apparatus to the second communication apparatus and the ratio.

5. The communication system according to claim 1, wherein:
the first communication apparatus comprises at least one of a shaper or a policer; and
the first communication apparatus adjusts, in accordance with the sub-path bandwidths indicated by the setting instruction transmitted from the control apparatus, a bandwidth for a packet to be output to each of the sub-paths by using the at least one of the shaper or the policer.

6. A communication apparatus configured to transfer a packet, comprising:
a processor;
a memory; and
a network interface, wherein:
the communication apparatus is coupled to a control apparatus via the network interface;
the communication apparatus is coupled to another communication apparatus via predetermined communication paths, a number of which is defined in advance, and the network interface; and
the processor is configured to:
receive a setting instruction to set sub-paths transmitted from the control apparatus, the setting instruction comprising:
information for identifying each of such sub-paths as to start from the communication apparatus to reach the another communication apparatus and that one of the sub-paths pass through one of the predetermined communication paths; and
information indicating sub-path bandwidths for the sub-paths defined by using available bandwidths for the predetermined communication paths;
receive the packets bound for the another communication apparatus;
classify the received packets into a predetermined number of groups by using a predetermined classification function;
assign the groups to the sub-paths respectively in accordance with a ratio among the sub-path bandwidths based on the setting instruction transmitted from the control apparatus; and
output each of the received packets to assigned one of the sub-paths.

7. The communication apparatus according to claim 6, wherein:
the communication apparatus is directly coupled to a first client-side apparatus;
the communication apparatus is coupled to a second client-side apparatus via the another communication apparatus; and
the communication apparatus is configured to:
receive a setting instruction transmitted from the control apparatus, the setting instruction comprising:
information for identifying a main path starting from the first client-side apparatus to reach the second client-side apparatus;
the information for identifying each of the sub-paths; and
the information indicating the sub-path bandwidths for the sub-paths defined by using the available bandwidths for the predetermined communication paths;
receive packets from the first client-side apparatus;
determine whether or not the information for identifying the main path is added to each of the received packets; and
classify, when the information for identifying the main path is added to the received packet, the received packets by using the predetermined classification function.

8. The communication apparatus according to claim 6, wherein the processor is configured to, as the predetermined classification function:
calculate hash values corresponding to the received packets by applying a hash function to information for identifying the received packets; and
classify the received packets based on the hash values.

9. The communication apparatus according to claim 6, further comprising at least one of a shaper or a policer,
wherein the processor adjusts, in accordance with the sub-path bandwidths indicated by the setting instruction transmitted from the control apparatus, a bandwidth for a packet to be output to each of the sub-paths by using the at least one of the shaper or the policer.

10. A control apparatus, which is coupled to a first communication apparatus and a second communication apparatus that are coupled to each other via a predetermined communication paths, a number of which is defined in advance, the control apparatus being configured to:
hold path information for identifying the predetermined communication paths coupling the first communication apparatus and the second communication apparatus to each other;
acquire an available bandwidth in each of the predetermined communication paths;
define, by using the path information, such sub-paths as to start from the first communication apparatus to reach the second communication apparatus and that one of the sub-paths pass through one of the communication paths;
determine sub-path bandwidths for the sub-paths in accordance with the acquired available bandwidths; and
transmit information for identifying each of the sub-paths and information indicating the sub-path bandwidths to the first communication apparatus by including the information in a setting instruction to set the sub-paths for the first communication apparatus and the second communication apparatus.

11. The control apparatus according to claim 10, wherein:
the control apparatus is coupled to a first client-side apparatus directly coupled to the first communication apparatus and a second client-side apparatus directly coupled to the second communication apparatus; and
the control apparatus is configured to:
acquire, when receiving a setting request for a main path starting from the first client-side apparatus to the second client-side apparatus, information for identifying the main path;
output a setting instruction for setting the main path to the first client-side apparatus, the second client-side apparatus, the first communication apparatus, and the second communication apparatus; and
transmit the information for identifying the main path, the information for identifying each of the sub-paths, and the information indicating the sub-path bandwidths to the first communication apparatus by including the information in the setting instruction.

12. The control apparatus according to claim 10, wherein the control apparatus is configured to:
acquire a bandwidth for transmitting packets from the first communication apparatus to the second communication apparatus;
calculate a ratio among the acquired available bandwidths for the communication paths; and
calculate each of the sub-path bandwidths for the sub-paths by using the bandwidth for transmitting packets from the first communication apparatus to the second communication apparatus and the calculated ratio.
